(19) United States
(12) Patent Application Publication
(10) Pub. No.: US 2019/0156792 A1
(43) Pub. Date: May 23, 2019

(54) METHOD AND SYSTEM FOR ADJUSTING DISPLAY CONTENT AND HEAD-MOUNTED DISPLAY

(71) Applicant: SHENZHEN ROYOLE TECHNOLOGIES CO. LTD., Shenzhen, Guangdong (CN)

(72) Inventor: Wuhua DENG, Shenzhen, Guangdong (CN)

(73) Assignee: SHENZHEN ROYOLE TECHNOLOGIES CO., LTD., Shenzhen, Guangdong (CN)

(21) Appl. No.: 16/300,305

(22) PCT Filed: Jan. 10, 2017
(86) PCT No.: PCT/CN2017/070776

§ 371 Date: Nov. 9, 2018

(51) Int. Cl. G09G 5/38; G06F 3/01; G09G 5/373

(52) U.S. Cl. CPC G09G 5/38; G06F 3/012; G09G 2340/0464; G09G 2354/00; G09G 2340/045; G09G 5/373

(57) ABSTRACT

The present disclosure relates to a method and a system for adjusting display content and a head-mounted display. The method includes the following. At S301, rotation parameters may be acquired by a sensor disposed in the head-mounted display when a head of a user rotates. At S302, whether a visual focus of the user changes is determined according to the rotation parameters when the head of the user rotates. If the visual focus of the user changes, the method proceeds to S303: adjusting the display content displayed on the head-mounted display. At S304, the display content adjusted may be displayed. Thus, when the head of the user rotates, the display content displayed on a display screen 110 of the head-mounted display is adjusted accordingly, which facilitates the user to view, such that the user experience is better.

### RELATED APPLICATIONS

The present application is a National Phase of International Application Number PCT/CN2017/070776, filed Jan. 10, 2017.

### TECHNICAL FIELD

This disclosure relates to the field of head-mounted displays, and more particularly to a method and a system for adjusting display content and a head-mounted display.

### BACKGROUND

Currently, a head-mounted display can adjust a display interface when a motion of a user's head is detected by the head-mounted display. For example, when the user's head rotates, a displaying position of display content will be adjusted, such that the user can view proper display content. However, for the existing head-mounted display, a problem is still existed: when the user's head rotates in a certain direction, the displaying position of the display content is still unadjusted, which is not favorable for the user to view the display content displayed on a specific position of the display screen.

### SUMMARY

In view of the above, a method and a system for adjusting display content and a head-mounted display are provided, so as to solve the above-described problems.

In order to solve the aforesaid technical problems, a method for adjusting display content is provided. The method includes the following. Rotation parameters are acquired by a sensor disposed in a head-mounted display when a head of a user rotates. Whether a visual focus of the user changes is determined according to the rotation parameters when the head of the user rotates. The display content displayed on the head-mounted display is adjusted based on a determination that the visual focus of the user changes. The display content adjusted is displayed.

According to an embodiment of the disclosure, a system for adjusting display content is provided. The system is applicable to a head-mounted display and includes an acquiring module, a determining module, an adjusting module, and a display control module. The acquiring module is configured to acquire rotation parameters by a sensor disposed in the head-mounted display when a head of a user rotates. The determining module is configured to determine whether a visual focus of the user changes according to the rotation parameters when the head of the user rotates. The adjusting module is configured to adjust the display content displayed on the head-mounted display based on a determination that the visual focus of the user changes. The display control module is configured to display the display content adjusted. In addition, a head-mounted display is further provided in the present disclosure. The head-mounted display includes a display screen, a sensor, and a processor. The processor is configured to execute the method for adjusting the display content.

Compared with the related art, in terms of the method and the system for adjusting the display content and the head-mounted display of the present disclosure, the display content displayed on a screen of the head-mounted display can be adjusted according to the user's head rotation, thereby providing convenience for watching and enhancing the user experience.

### BRIEF DESCRIPTION OF THE DRAWINGS

FIG. 1 is a schematic diagram illustrating a hardware environment in which a system for adjusting display content is operated according to an embodiment of the present disclosure;

FIG. 2 is a schematic diagram illustrating functional modules of the system for adjusting the display content illustrated in FIG. 1; and

FIG. 3 is a flow chart illustrating a method for adjusting display content according to an embodiment of the present disclosure.

### DETAILED DESCRIPTION OF ILLUSTRATED EMBODIMENTS

In order to enable objects, technical solutions, and advantages of the present disclosure to be clearer, the present disclosure will be further described in detail hereinafter with reference to accompanying drawings and embodiments. It should be understood that the specific embodiments described herein are merely illustrative of the present disclosure and are not intended to limit the present disclosure.

It should also be noted that, terms “left”, “right”, “upper”, and “lower” in this embodiment are merely relative concepts or refer to the normal use of the product, and should not be considered as restrictive.

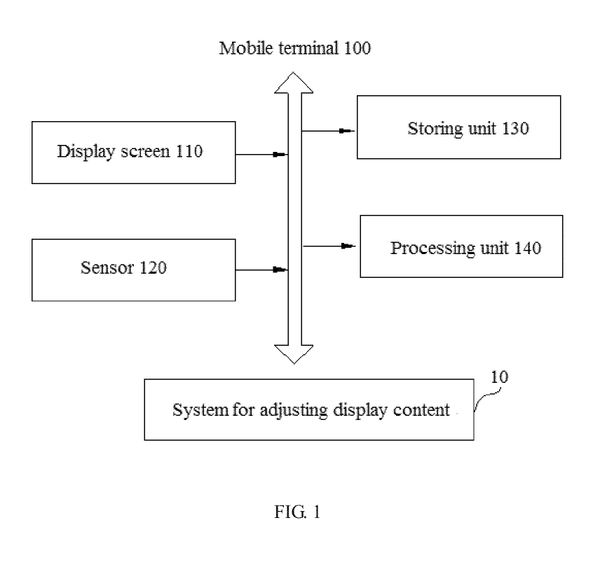

FIG. 1 is a schematic diagram illustrating an operation environment in which a system 10 (hereinafter referred to as an “adjusting system 10”) for adjusting display content is operated according to an embodiment of the present disclosure. The adjusting system 10 is installed and operated on a mobile terminal 100. In this embodiment, the mobile terminal 100 refers to a head-mounted display. In other embodiments, the mobile terminal 100 may be a mobile phone, a tablet PC, a personal digital assistant, a navigation device, and the like.

The mobile terminal 100 includes, but is not limited to, a display screen 110, a sensor 120, a storing unit 130, and a processing unit 140. The display screen 110 is configured to display certain display content to a user. The display content includes pictures, texts, video information, or the like.

The sensor 120 is configured to acquire rotation parameters when a head of the user rotates. In an implementation, the sensor 120 may include a three-axis gravity sensor and a three-axis gyroscope disposed on the head-mounted display. The three-axis gravity sensor together with the three-axis gyroscope is configured to acquire six-axis data when the head of the user rotates. In another implementation, the sensor 120 may include a three-axis gravity sensor, a three-axis gyroscope, and a three-axis geomagnetic sensor disposed on the head-mounted display. The three-axis gravity sensor, the three-axis gyroscope, and the three-axis geomagnetic sensor are configured to acquire nine-axis data together when the head of the user rotates.

The storing unit 130 may be an internal storing unit of the mobile terminal 100, such as a hard disk or a memory of the mobile terminal 100. The storing unit 130 may also be an external storage device of the mobile terminal 100, such as a plug-in type hard disk, a smart media card (SMC), a secure digital card (SDC), a flash card (FC), and the like, which are disposed on the mobile terminal 100. Further, the storing unit 130 may also include both an internal storing unit of the mobile terminal 100 and an external storage device of the mobile terminal 100. The storing unit 130 is configured to store program codes and data required for operations of a device for preventing accidental touches of buttons. The processing unit 140 serves as a control center of the mobile terminal 100 and is configured to control operations of the mobile terminal 100. The processing unit 140 may be a central processing unit (CPU), a single-chip microcomputer, a digital signal processor, and the like. The processing unit 140 is configured to execute program codes stored in the storing unit 130 or process data, for example, the processing unit 140 is configured to execute the adjusting system 10 of the display content.

The processing unit 140 is communicatively coupled with the display screen 110, the sensor 120, and the storing unit 130 through a system bus. FIG. 1 illustrates only some components of the mobile terminal 100. However, those skilled in the art will appreciate that the mobile terminal 100 may include other components such as a communication interface (not shown) in addition to the components illustrated in FIG. 1.

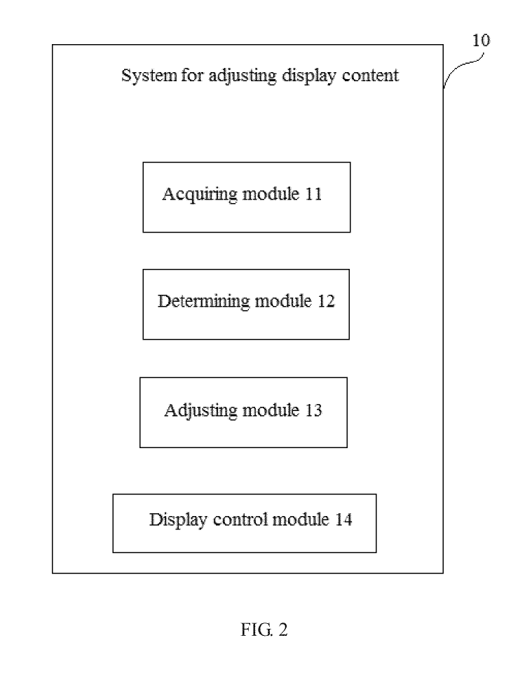

FIG. 2 is a schematic diagram illustrating functional modules of the system 10 for adjusting the display content according to an embodiment of the present disclosure. The adjusting system 10 includes, but is not limited to, an acquiring module 11, a determining module 12, an adjusting module 13, and a display control module 14. It should be noted that the modules referred to herein may be program instruction segments that can be executed by the processing unit 140 of the mobile terminal 100 and that can perform certain functions. The functions of the above functional modules will be further described in detail below.

The acquiring module 11 is configured to acquire rotation parameters by the sensor 120 disposed in the head-mounted display when the user's head rotates. The rotation parameters may include information such as rotate angles, rotate directions, rotate distances, or the like. In an implementation, the acquiring module 11 can control the sensor 120 to acquire the rotation parameters in real time while the head of the user rotates. In another implementation, the acquiring module 11 can control the sensor 120 to acquire the rotation parameters in a preset time interval, such as 5 seconds, when the head of the user rotates.

The determining module 12 is configured to determine whether a visual focus of the user changes according to the rotation parameters acquired by the acquiring module 11 when the head of the user rotates.

In an implementation, before the head of the user rotates, the determining module 12 firstly calculates a first two-dimensional coordinate of the visual focus of the user in a coordinate system and temporarily stores the first two-dimensional coordinate in the storing unit 130. The coordinate system is defined in a plane of the display screen 110 of the head-mounted display. After the head of the user begins to rotate, the determining module 12 calculates a second two-dimensional coordinate of the visual focus of the user in the coordinate system according to the rotation parameters acquired by the acquiring module 11. Thereafter, the determining module 12 compares the first two-dimensional coordinate and the second two-dimensional coordinate to determine whether the visual focus of the user changes according to a compared result. The adjusting module 13 adjusts the display content displayed on the head-mounted display when the determining module 12 determines that the visual focus of the user changes. The display control module 14 is configured to display the display content adjusted by the adjusting module 13.

In an implementation, the determining module 12 compares the first two-dimensional coordinate and the second two-dimensional coordinate, and when the first two-dimensional coordinate is different from the second two-dimensional coordinate, or when a horizontal coordinate value of the first two-dimensional coordinate is different from that of the second two-dimensional coordinate, the determining module 12 can determine that the visual focus of the user changes. In other implementations, when a difference between the first two-dimensional coordinate and the second two-dimensional coordinate is greater than a preset value, the determining module 12 can determine that the visual focus of the user changes in the case that the head of the user rotates.

In an implementation, the adjusting module 13 is configured to zoom in display content displayed on a display area where the second two-dimensional coordinate is located, and the display control module 14 is configured to display the display content zoomed-in.

In another implementation, the adjusting module 13 is configured to move display content displayed on a display area where the second two-dimensional coordinate is located, to a central position of the display screen 110.

In order to provide a better view experience for the user, the determining module 12 further determines whether the head of the user rotates back, the head of the user rotates back refers to that the head of the user rotates in a first direction and then rotates in a second direction, and an angle between the first direction and the second direction is not equal to 90°. In another embodiment, a projection of the second direction overlaps that of the first direction.

In order to facilitate the user to clearly know a current position of the visual focus of the user, the display control module 14 can display a preset identifier at the current position of the visual focus of the user, where the preset identifier may be a cursor or an icon.

With aid of the adjusting system 10, when the user wants to watch the display content on the left, right, upper, or lower of the display screen 110, the user can rotate the head accordingly and can position the visual focus of the user on the content to be viewed, and then the adjusting system 10 may adjust the display content displayed on the head-mounted display, such that the display content at the current position of the visual focus of the user can be displayed on the central position of the display screen 110. Thus, after the head rotates, the user can watch the display content adjusted without biasing the head for a long time, such that the user experience is better.

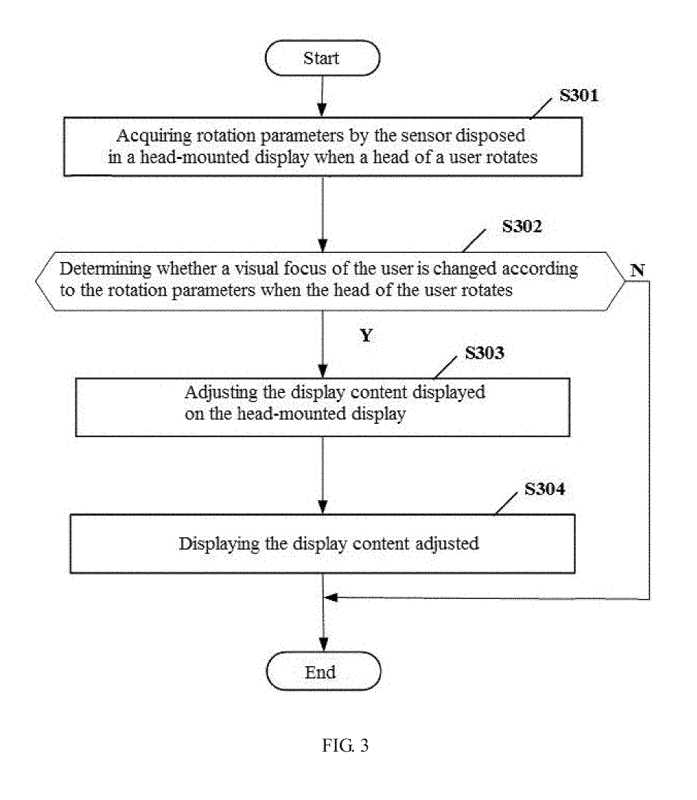

FIG. 3 is a flow chart illustrating a method for adjusting display content according to an embodiment of the present disclosure. In this embodiment, an execution sequence of blocks illustrated in FIG. 3 may be changed and some blocks may be omitted according to specific cases.

At S301, rotation parameters are acquired by the sensor 120 disposed in a head-mounted display when a head of a user rotates. If the head of the user rotates, the method proceeds to S302; otherwise, the method ceases to proceed.

In an implementation, the acquiring module 11 controls the sensor 120 to acquire the rotation parameters in real time while the head of the user is rotating. In another implementation, the acquiring module 11 controls the sensor 120 to acquire the rotation parameters in a preset time interval, such as 5 seconds, while the head of the user is rotating. The rotation parameters include information such as rotate angles, rotate directions, rotate distances, or the like.

In an implementation, the sensor 120 may include a three-axis gravity sensor and a three-axis gyroscope disposed on the head-mounted display. The three-axis gravity sensor and the three-axis gyroscope can acquire six-axis data when the head of the user rotates. In another implementation, the sensor 120 may include a three-axis gravity sensor, a three-axis gyroscope, and a three-axis geomagnetic sensor disposed on the head-mounted display. The three-axis gravity sensor, the three-axis gyroscope, and the three-axis geomagnetic sensor can acquire nine-axis data when the head of the user rotates.

At S302, whether a visual focus of the user changes is determined according to the rotation parameters when the head of the user rotates. If the visual focus of the user changes, the method proceeds to S303. Otherwise, the method ceases to proceed.

In an implementation, S302 may include the following. Before the head of the user rotates, the determining module 12 firstly calculates a first two-dimensional coordinate of the visual focus of the user in a coordinate system, and temporarily stores the first two-dimensional coordinate in the storing unit 130. The coordinate system is defined in a plane of the display screen 110 of the head-mounted display. After the head of the user begins to rotate, the determining module 12 calculates a second two-dimensional coordinate of the visual focus of the user in the coordinate system according to the rotation parameters acquired by the acquiring module 11. Thereafter, the determining module 12 compares the first two-dimensional coordinate and the second two-dimensional coordinate to determine whether the visual focus of the user changes according to a compared result. In an implementation, when the first two-dimensional coordinate is different from the second two-dimensional coordinate, the determining module 12 will determine that the visual focus of the user changes. In another implementation, when a horizontal coordinate value of the first two-dimensional coordinate is different from that of the second two-dimensional coordinate, the determining module 12 will determine that the visual focus of the user changes in the case that the head of the user rotates. In other implementations, when a difference between the first two-dimensional coordinate and the second two-dimensional coordinate is greater than a preset value, the determining module 12 will determine that the visual focus of the user changes in the case that the head of the user rotates.

In an implementation, the visual focus can be identified by a preset identifier, and the user can be aware of where the visual focus is located by displaying the identifier. Identifying the visual focus can be realized using an existing technology that is not repeatedly described herein.

At S303, the display content displayed on the head-mounted display can be adjusted.

In an implementation, S303 may include the following. Display content displayed on a display area where the second two-dimensional coordinate is located may be zoomed-in. The display content zoomed-in may be displayed.

In another implementation, S303 may include the following. Display content displayed on a display area where the second two-dimensional coordinate is located may be moved to the central position of the display screen 110.

In other implementations, the method further includes the following prior to S303. Whether the head of the user rotates back is determined, the head of the user rotates back refers to that the head of the user rotates in a first direction and then rotates in a second direction, and an angle between the first direction and the second direction is not equal to 90°. In another embodiment, a projection of the second direction overlaps that of the first direction.

At S304, the display content adjusted may be displayed.

While the present disclosure has been described in detail above with reference to the exemplary embodiments, the scope of the present disclosure is not limited thereto. As will occur to those skilled in the art, the present disclosure is susceptible to various modifications and changes without departing from the spirit and principle of the present disclosure. Therefore, the scope of the present disclosure should be determined by the scope of the claims.

1. What is claimed is:

1. A method for adjusting display content, comprising:
acquiring rotation parameters by a sensor disposed in a head-mounted display when a head of a user rotates;
determining whether a visual focus of the user changes according to the rotation parameters when the head of the user rotates;
adjusting display content displayed on the head-mounted display based on a determination that the visual focus of the user changes; and
displaying the display content adjusted.

2. The method of claim 1, wherein the determining whether a visual focus of the user changes according to the rotation parameters when the head of the user rotates comprises:
calculating a first two-dimensional coordinate of the visual focus of the user in a coordinate system before the head of the user rotates, the coordinate system being defined in a plane of the display screen of the head-mounted display;
calculating a second two-dimensional coordinate of the visual focus of the user in the coordinate system according to the rotation parameters acquired, after the head of the user begins to rotate;
comparing the first two-dimensional coordinate and the second two-dimensional coordinate; and
determining whether the visual focus of the user changes according to a compared result.

3. The method of claim 2, comprising:
determining that the visual focus of the user changes when the first two-dimensional coordinate is different from the second two-dimensional coordinate.

4. The method of claim 3, comprising:
determining that the visual focus of the user changes when a horizontal coordinate value of the first two-dimensional coordinate is different from that of the second two-dimensional coordinate.

5. The method of claim 3, wherein the adjusting display content displayed on the head-mounted display comprises:
zooming-in display content displayed on a display area where the second two-dimensional coordinate is located; and
displaying the display content zoomed-in.

6. The method of claim 3, wherein the adjusting display content displayed on the head-mounted display comprises:
moving display content displayed on a display area where the second two-dimensional coordinate is located, to a central position of the display screen.

7. The method of claim 6, further comprising:
prior to the moving display content displayed on a display area where the second two-dimensional coordinate is located, to a central position of the display screen, determining whether the head of the user rotates back, wherein the head of the user rotates back refers to that the head of the user rotates in a first direction and then rotates in a second direction, and an angle between the first direction and the second direction is not equal to 90°.

8. The method of claim 1, further comprising:
displaying the visual focus with a preset identifier.

9. A system for adjusting display content, running a head-mounted display, comprising:
an acquiring module, configured to acquire rotation parameters by a sensor disposed in the head-mounted display when a head of a user rotates;
a determining module, configured to determine whether a visual focus of the user changes according to the rotation parameters when the head of the user rotates;
an adjusting module, configured to adjust display content displayed on the head-mounted display based on a determination that the visual focus of the user changes; and
a display control module, configured to display the display content adjusted.

10. The system of claim 9, wherein the determining module is further configured to:
calculate a first two-dimensional coordinate of the visual focus of the user in a coordinate system before the head of the user rotates, wherein the coordinate system is defined in a plane of the display screen of the head-mounted display;
calculate a second two-dimensional coordinate of the visual focus of the user in the coordinate system according to the rotation parameters acquired, after the head of the user begins to rotate;
compare the first two-dimensional coordinate and the second two-dimensional coordinate; and
determine whether the visual focus of the user changes according to a compared result.

11. The system of claim 10, wherein the determining module is configured to:
determine that the visual focus of the user changes when the first two-dimensional coordinate is different from the second two-dimensional coordinate.

12. The system of claim 11, wherein the determining module is configured to:
determine that the visual focus of the user changes when a horizontal coordinate value of the first two-dimensional coordinate is different from that of the second two-dimensional coordinate.

13. The system of claim 11, wherein
the adjusting module is configured to zoom in display content displayed on a display area where the second two-dimensional coordinate is located; and
the display control module is configured to display the display content zoomed-in.

14. The system of claim 11, wherein the adjusting module is configured to move display content displayed on a display area where the second two-dimensional coordinate is located, to a central position of the display screen.

15. The system of claim 14, wherein the determining module is further configured to:
determine whether the head of the user rotates back, wherein the head of the user rotates back refers to that the head of the user rotates in a first direction and then rotates in a second direction, and an angle between the first direction and the second direction is not equal to 90°.

16. The system of claim 15, wherein the display control module is further configured to display the visual focus with a preset identifier.

17. A head-mounted display, comprising a display screen, a sensor, and a processor, the processor being configured to:
acquire rotation parameters by a sensor disposed in a head-mounted display when a head of a user rotates;
determine whether a visual focus of the user changes according to the rotation parameters when the head of the user rotates;
adjust display content displayed on the head-mounted display based on a determination that the visual focus of the user changes; and
display the display content adjusted.

18. The head-mounted display of claim 17, wherein the processor configured to determine whether a visual focus of the user changes according to the rotation parameters when the head of the user rotates is configured to:
calculate a first two-dimensional coordinate of the visual focus of the user in a coordinate system before the head of the user rotates, the coordinate system being defined in a plane of the display screen of the head-mounted display;
calculate a second two-dimensional coordinate of the visual focus of the user in the coordinate system according to the rotation parameters acquired, after the head of the user begins to rotate;
compare the first two-dimensional coordinate and the second two-dimensional coordinate; and
determine whether the visual focus of the user changes according to a compared result.

19. The head-mounted display of claim 18, wherein the processor is configured to:
determine that the visual focus of the user changes when the first two-dimensional coordinate is different from the second two-dimensional coordinate.

20. The head-mounted display of claim 19, wherein the processor is configured to:
determine that the visual focus of the user changes when a horizontal coordinate value of the first two-dimensional coordinate is different from that of the second two-dimensional coordinate.
